(19) United States
(12) Patent Application Publication
(10) Pub. No.: US 2021/0157135 A1
(43) Pub. Date: May 27, 2021

(54) HEAD-UP DISPLAY IMAGE ACQUISTION AND CORRECTION

(71) Applicant: GM GLOBAL TECHNOLOGY OPERATIONS LLC, Detroit, MI (US)

(72) Inventors: James W. Wells, Rochester Hills, MI (US); Jinglin Li, Sterling Heights, MI (US); Todd H. Barnes, Grand Blanc, MI (US)

(21) Appl. No.: 16/696,093

(22) Filed: Nov. 26, 2019

(51) Int. Cl. G02B 27/01; G06T 5/00; G06T 7/30; G06T 7/90; G06T 7/00; B60K 35/00

(52) U.S. Cl. CPC G02B 27/0101; B60K 2370/736; G06T 7/30; G06T 7/90; G06T 7/0002; G02B 27/0149; B60K 35/00; G06T 2207/30168; G06T 2207/30268; G02B 2027/011; G02B 2027/0112; G02B 2027/0138; G02B 2027/014; G02B 2027/0154; B60K 2370/1529; B60K 2370/166; B60K 2370/168; B60K 2370/167; B60K 2370/31; B60K 2370/21; B60K 2370/52; G06T 5/006

(57) ABSTRACT

A HUD image acquisition and correction apparatus and method for a vehicle includes a HUD patch defined upon a reflective surface of a windshield of the vehicle, a virtual image generator for projecting images within the HUD patch, and a virtual image sensor assembly located within a HUD eyebox region of the vehicle and having a field of view including the HUD patch. A controller is configured to control projection of a predetermined test image within the HUD patch, receive from the virtual image sensor assembly a HUD patch image, determine a compensation function based upon the predetermined test image and the HUD patch image, and provide to the virtual image generator the compensation function for application to raw images prior to projection.

### INTRODUCTION

This disclosure is related to head-up displays (HUD).

A HUD is a display that presents data in a partially transparent manner and at a position allowing a user to see it without having to look away from his/her usual viewpoint (e.g., substantially forward). Although developed for military use, HUDs are now used in commercial aircraft, automobiles, computer gaming, and other applications.

Within vehicles, HUDs may be used to project virtual images or vehicle parameter data in front of the vehicle windshield or surface so that the image is in or immediately adjacent to the operator's line of sight. Vehicle HUD systems can project data based on information received from operating components (e.g., sensors) internal to the vehicle to, for example, notify users of lane markings, identify proximity of another vehicle, or provide nearby landmark information.

HUDs may also receive and project information from information systems external to the vehicle, such as a navigational system on a smartphone. Navigational information presented by the HUD may include, for example, projecting distance to a next turn and current speed of the vehicle as compared to a speed limit, including an alert if the speed limit is exceeded. External system information advising what lane to be in for an upcoming maneuver or warning the user of potential traffic delays can also be presented on the HUD.

HUDs may also be employed in augmented reality displays or enhanced vision systems that identify, index, overlay or otherwise reference objects and road features including infrastructure. Such advanced systems require precision alignment of HUD images relative to the observers within the vehicle and objects within their field of view. Moreover, such HUD systems may employ the windshield to provide HUD combiner functionality over a wide field of view. Such large format reflective displays present challenges to the designer with respect to image location and distortion.

### SUMMARY

In one exemplary embodiment, a HUD image acquisition and correction apparatus for a vehicle includes a HUD patch defined upon a reflective surface of a windshield of the vehicle, a virtual image generator for projecting images within the HUD patch, and a virtual image sensor assembly located within a HUD eyebox region of the vehicle and having a field of view including the HUD patch. The apparatus further includes a controller configured to control projection of a predetermined test image within the HUD patch, receive from the virtual image sensor assembly a HUD patch image, determine a compensation function based upon the predetermined test image and the HUD patch image, and provide to the virtual image generator the compensation function for application to raw images prior to projection.

In addition to one or more of the features described herein, the compensation function may include a distortion compensation function.

In addition to one or more of the features described herein, the compensation function may include an alignment compensation function.

In addition to one or more of the features described herein, the compensation function may include a color compensation function.

In addition to one or more of the features described herein, the apparatus may include a fixture for the virtual image sensor assembly, the fixture locating the virtual image sensor assembly within the HUD eyebox region of the vehicle.

In addition to one or more of the features described herein, the fixture may be fixedly attached to a static vehicle structure.

In addition to one or more of the features described herein, the fixture may be fixedly attached to a seat back.

In addition to one or more of the features described herein, the fixture may be fixedly attached to a robot assembly.

In addition to one or more of the features described herein, the virtual image sensor assembly may include at least one camera.

In addition to one or more of the features described herein, the virtual image sensor assembly may include a plurality of individually, positionally adjustable cameras.

In addition to one or more of the features described herein, the apparatus may include comprising an alignment system for locating the virtual image sensor assembly within the HUD eyebox region.

In addition to one or more of the features described herein, the alignment system for locating the virtual image sensor assembly within the HUD eyebox region may include a laser alignment system.

In addition to one or more of the features described herein, the alignment system for locating the virtual image sensor assembly within the HUD eyebox region may include a camera.

In addition to one or more of the features described herein, the camera may include the virtual image sensor assembly.

In addition to one or more of the features described herein, the apparatus may include seat positioning motors, the controller configured to control the seat positioning motors to move the fixture and virtual image sensor assembly into a final desired position within the HUD eyebox region.

In another exemplary embodiment, a HUD image acquisition and correction apparatus for a vehicle includes a HUD patch defined upon a reflective surface of a windshield of the vehicle, a virtual image generator for projecting images within the HUD patch, and a virtual image sensor assembly located within a HUD eyebox region of the vehicle and having a field of view including the HUD patch, the virtual image sensor assembly including a plurality of cameras. The apparatus further includes a controller configured to control projection of a predetermined test image within the HUD patch, receive from the virtual image sensor assembly a HUD patch image including the predetermined test image reflected off the reflective surface of the windshield, the HUD patch image providing information corresponding to distortion effects of the reflective surface within the HUD patch to the controller, determine a distortion compensation function based upon the predetermined test image and the HUD patch image, the distortion compensation function effective to counteract the distortion effects of the reflective surface within the HUD patch, and provide to the virtual image generator the compensation function for application to raw images prior to projection.

In addition to one or more of the features described herein, the apparatus may include a fixture for the virtual image sensor assembly, the fixture locating the virtual image sensor assembly within the HUD eyebox region of the vehicle.

In addition to one or more of the features described herein, the apparatus may include the fixture fixedly attached to one of a static vehicle structure, a seat back, and a robot assembly.

In yet another exemplary embodiment, HUD image acquisition and correction method for a vehicle includes projecting a predetermined test image within a HUD patch defined upon a reflective surface of a windshield of the vehicle, receiving from a virtual image sensor assembly located within a HUD eyebox region of the vehicle and having a field of view including the HUD patch a HUD patch image including the predetermined test image reflected off the reflective surface of the windshield, determining a compensation function based upon the predetermined test image and the HUD patch image, and providing to the virtual image generator the compensation function for application to raw images prior to projection.

In addition to one or more of the features described herein, the compensation function may include at least one of a distortion compensation function, an alignment compensation function, and a color compensation function.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 illustrates a HUD system in accordance with the present disclosure;

FIG. 2A illustrates a side view of a vehicle interior, in accordance with the present disclosure;

FIG. 2B illustrates a forward-looking view of a vehicle interior, in accordance with the present disclosure;

FIG. 2C illustrates a perspective view of a seating area and eyebox region in a vehicle interior, in accordance with the present disclosure;

FIG. 3 illustrates a front view of an exemplary camera array in a virtual image sensor assembly, in accordance with the present disclosure; and

FIG. 4 illustrates an exemplary process for image acquisition and correction, in accordance with the present disclosure.

### DETAILED DESCRIPTION

The following description is merely exemplary in nature and is not intended to limit the present disclosure, its application, or uses. It should be understood that throughout the drawings, corresponding reference numerals indicate like or corresponding parts and features. As used herein, control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A controller may include a variety of communication interfaces including point-to-point or discrete lines and wired or wireless interfaces to networks including wide and local area networks, on vehicle networks (e.g. Controller Area Network (CAN), Local Interconnect Network (LIN)) and in-plant and service-related networks. Controller functions as set forth in this disclosure may be performed in a distributed control architecture among several networked controllers. Software, firmware, programs, instructions, routines, code, algorithms and similar terms mean any controller executable instruction sets including calibrations, data structures, and look-up tables. A controller may have a set of control routines executed to provide described functions. Routines are executed, such as by a central processing unit, and are operable to monitor inputs from sensing devices and other networked controllers and execute control and diagnostic routines to control operation of actuators. Routines may be executed at regular intervals during ongoing engine and vehicle operation. Alternatively, routines may be executed in response to occurrence of an event, software calls, or on demand via user interface inputs or requests.

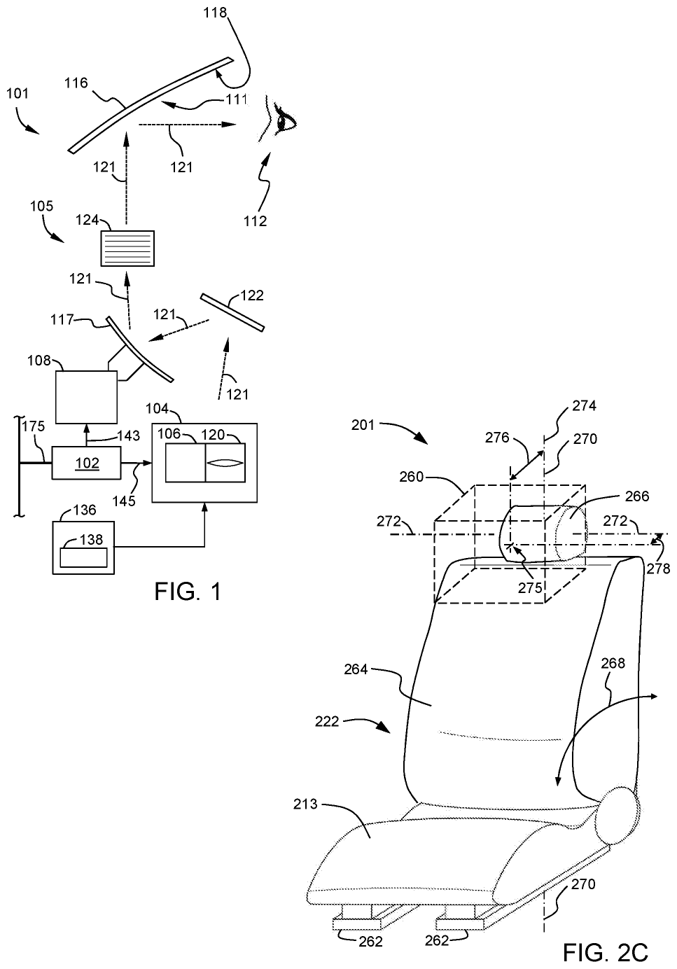

FIG. 1 schematically illustrates an exemplary HUD system 101 in accordance with the present disclosure. The HUD system 101 includes a reflective display which is preferably windshield 116 providing a reflective surface 118 such as an inner layer of glass of a laminated windshield. The windshield 116 includes a HUD patch 111 which generally refers to a region of the windshield 116 wherein HUD virtual images may be projected for display to observer 112. The HUD system 101 may include a controller 102, a virtual image generator 105 including a picture generation unit (PGU) 104 with image light source 106 and display and lens assembly 120, one or more fold mirrors 122, adjustable mirror 117 and associated mirror actuator 108, and light and glare traps 124. HUD system 101 may further include other features, components and subsystems including, for example, an illumination projector and/or an image sensor (not shown). An image corresponding to the HUD patch (HUD patch image) is understood to mean an image appearing within the HUD patch. The controller 102 may be networked with other electronic control units, sensors and user interface (UI), both on-board and off-board the vehicle, for example via bus 175 which may be a CAN bus. Off board networking may be particularly useful in the controlled production environment of a final assembly plant and the after-sale field service environment. Controller 102 controls operation of the PGU 104 including image light source 106 via control line 145 to generate a virtual image. The controller 102 controls operation of the mirror actuator 108 via control line 143 to rotate or tilt a mirror 117 and adjust where on windshield the HUD virtual image is projected. The mirror actuator may include a motor, gears, shafts, and/or other components to change the position and/or orientation of the mirror 117. The mirror 117 may magnify the image generated by the PGU 104 and/or correct certain distortions associated with the windshield 116.

The PGU 104 may include the image light source 106 and a display and lens assembly 120. The image light source 106 generates a virtual image light beam 121 including graphic images that are projected onto a display of the display and lens assembly 120. The virtual image light beam 121 is then directed at a series of one or more fold mirrors 122. The one or more fold mirrors 122 may be used for packaging considerations. The virtual image light beam 121 is reflected at the mirror 117 and then may be reflected through light and glare traps 124 to the windshield 116. The virtual image light beam 121 is displayed on the windshield which serves as the HUD combiner. The light and glare traps 124 may filter and thus prevent, for example, sun light (or ambient light) from being reflected from the windshield 116 towards the mirror 117 and minimize effects of glare.

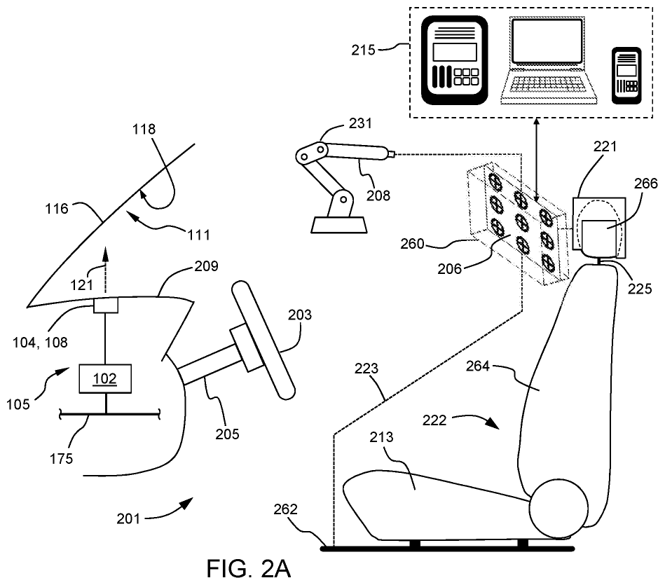

The HUD system 101 may further include and/or be connected to a manual controller 136 including switches (buttons, paddles, sliders, rotaries, joysticks or the like) 138. The HUD system 101 may also include and/or be connected to a display, seat motors, or seat switches (not separately illustrated). The display may be, for example, a touchscreen, such as an infotainment display (265, FIG. 2B) located in a center console of a vehicle, or other display. The seat motors are used to position one or more seats. The controller 102 may control operations of the seat motors based on user inputs via the seat switches and/or seat settings stored in memory. The manual controller 136 may be used by a user to manually adjust the height of virtual images provided by the PGU 104 via the switches 138. Alternatively, a display touchscreen may provide a user interface (UI) for manual adjustments of the HUD virtual image during end user application such as by a vehicle occupant. Such a display, seat switches and switches 138 may be referred to as input devices and/or interfaces or more generally as a user interface. In limited circumstances in accordance with the present disclosure, the input devices may provide a user interface to establish user intent or control of an automated or partially automated alignment procedure for the HUD virtual image.

Certain HUD applications require precise alignment of the virtual images produced by the HUD. Placement of simple information upon the windshield, such as conventional engine gauge display, is not positionally critical. However, augmented reality systems intended to improve driver or occupant situational awareness by identifying, overlaying, or otherwise enhancing visibility of objects or features located on a road scene require virtual image placement taking into consideration the observer's eye position, the scene object position and the vehicle windshield position. In order to enable robust virtual image placement fidelity in such systems, the virtual image position must be calibrated relative to the vehicle reference frame. In addition to positional precision, geometric accuracy and undistorted images as perceived by the observer are desirable.

In accordance with an exemplary embodiment, FIGS. 2A-2C are illustrative views showing an example of a portion of the interior of a vehicle 201 incorporating a HUD system and image acquisition apparatus in accordance with the present disclosure. Dashboard assembly 209 extends laterally within the vehicle cabin substantially forward of the doors and beneath and between the A-pillars 207. A-pillars 207 frame the windshield 116. Steering wheel 203 is located forward of the driver seat 222 and is coupled to a steering column assembly 205.

Assembly of virtual image generator 105 into the vehicle may be accomplished by the installation of an entire dash assembly into which the virtual image generator 105 has been assembled as part of a subassembly process or build-up of the dash assembly 209. Alternatively, a smaller subassembly including an instrument cluster pod may contain the virtual image generator 105 and may be assembled to the dash assembly already installed within the vehicle. Alternatively, the virtual image generator 105 may be assembled into the instrument cluster, dash assembly or upper dash pad as a separate assembly component. Virtual image generator 105 is adapted and controlled to project virtual image light beam 121 toward windshield 116 within the HUD patch 111.

In accordance with the present disclosure, it may be desirable to align images and/or color channels displayed within the HUD patch by virtual image generator 105 and to characterize or instrument the reflective surface 118 of the windshield 116 at the HUD patch 111. Such adjustments may be made manually or autonomously. For example, the user may adjust a projected image through manual controller 136. Alternatively, such adjustment may be effected in an automated process including HUD patch image sensing. Adjustments of the virtual image may be implemented in various ways depending upon the particular hardware configuration of the HUD system 101 and, more particularly, of the virtual image generator 105. Optical effects also may be imparted by the reflective surface 118 of the windshield 116 within the HUD patch 111 upon the virtual images projected by the virtual image generator 105. Thus, curvature, waves, dimples and other imperfections in the windshield may become apparent to the observer 112 of reflected images. With respect to such distortion effects imparted by the reflective surface 118 of the windshield 116, adjustments to the projected virtual image may be made to counteract such effects. Adjustment may be made by well-known image distortion or warping engines implemented within the PGU, controller 102 or other off-vehicle processor. Preferably, such corrections are implemented in non-volatile memory associated with the PGU 104 as a calibration thereto and applied to raw images provided by controller 102 for projection and display. Alternatively, such corrections may be implemented in non-volatile memory associated with the controller 102 as a calibration thereto which applies corrections to raw images prior to provision to the PGU 104 for projection and display. Such corrections or compensations may generally be referred to as compensation functions. Counteracting such distortions may require characterizing, instrumenting or otherwise mapping the reflective surface 118 at the HUD patch. Therefore, it may be desirable for virtual image alignment and distortion corrections to sense the virtual image within the HUD patch. More particularly, sensing of the virtual image within the HUD patch may be accomplished substantially from the desirable perspective of an observer 112. It is envisioned that such alignment and distortion corrections are infrequently required, for example during initial vehicle assembly, windshield replacement, or virtual image generator 105 removal and replacement.

Virtual image sensing from the perspective of an observer 112 may be accomplished generally within a HUD eyebox region 260 associated with the HUD system 101. In accordance with the present disclosure, a virtual image sensor assembly 206 is located within the HUD eyebox region 260. FIG. 2C is a perspective view illustrating an example of a HUD eyebox region 260 located within an interior of a vehicle, referred to generally herein as eyebox 260. While illustrated as cube-shaped in FIG. 2C, it is contemplated that the eyebox 260 may define another shape, such as a rectangular prism as illustrated in FIG. 2A, without departing from a scope of this disclosure. In another example, the eyebox 260 may include a plane intersecting a center 275 of the eyebox 260 or a plane spaced from the center 275. The plane may be representative of a desired location of a driver's eyes within the vehicle interior. A location and size of the eyebox 260 may be based off of a size and location of the driver seat 222 located within the interior of the vehicle 201.

In the figures, driver seat 222 is illustrated and includes adjustable seat cushion 213, adjustable seat back 264, and adjustable headrest 266. The seat is movably fastened to seat rails 262 and, within limits, may be able to raise, lower, tilt, and move fore/aft. The seatback 264 is hinged toward its bottom at the rear of the seat bottom 213 for pivotal movement as represented by arrow 268. Headrest 266 is secured to the seatback 264 via posts 225 disposed within post guides at the top of seatback 264. Headrest 266 is adjustable up and down and may articulate or rotate, also within limits. The seatback 264 may define a seatback axis 270. The headrest 266 may define a horizontal axis 272 and a vertical axis 274. The horizontal axis 272 may be substantially perpendicular to the seatback axis 270. The seatback 264 and the headrest 266 may be arranged with one another such that the seatback axis 270 and the vertical axis 274 share a same axis. For example, when the seatback 264 is oriented substantially upright and the headrest 266 is oriented substantially upright, the seatback axis 270 and the vertical axis 274 share a same axis as shown in FIG. 2C. Seat adjustments may be made manually, through power operation, or a combination of both. The vehicle user may establish a seating position and hence the observer's eye position. Eyebox 260 is located generally in front of the seat back 264 at the general height of the headrest 266.

A location of the center 275 of the eyebox 260 may be based off of the seatback axis 270, the horizontal axis 272, and/or the vertical axis 274. The center 275 may be spaced equidistantly from each side of the eyebox 260 when the eyebox region is shaped as a cube. The center 275 may be spaced from the seatback axis 270 and/or the vertical axis 274 a distance represented by a dimension 276. The distance represented by the dimension 276 may be a dimension selected to orient the eyebox 260 at a location based on a representative location of an observer's eyes. In one example, the distance represented by dimension 276 may be substantially equal to between 20 and 100 millimeters. In another example, a location of the eyebox 260 may also be based off of a distance represented by dimension 278. The distance represented by dimension 278 may be substantially equal to between 0 and 5 millimeters.

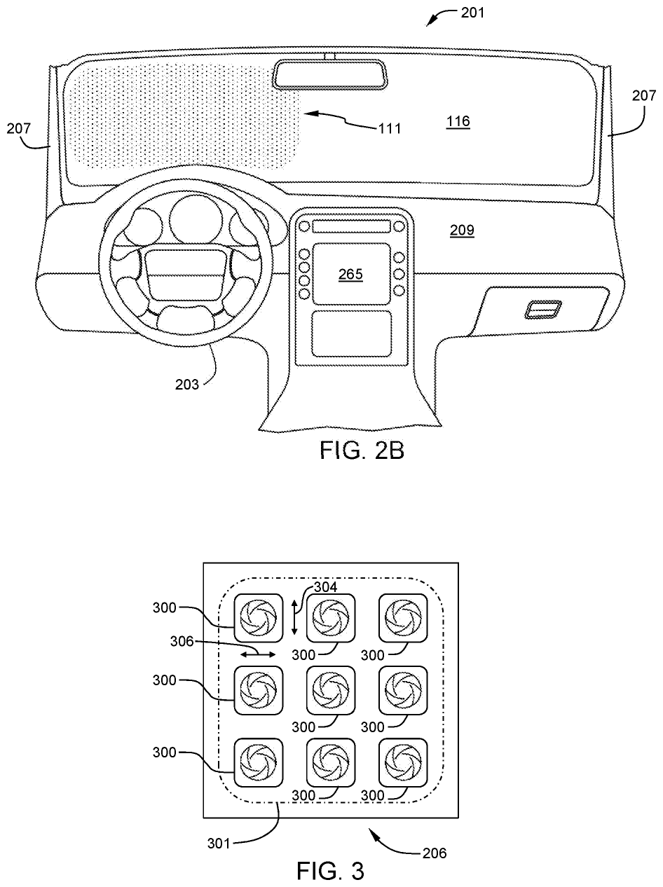

A virtual image sensor assembly 206 may include one or more sensors to simulate an observer's view of the HUD patch 111. Virtual image sensor assembly 206 therefore has a field of view which includes the HUD patch 111. In one example, the virtual image sensor assembly 206 may include a camera array having multiple cameras. An exemplary virtual image sensor assembly 206 is illustrated in FIG. 3. In this example, the virtual image sensor assembly 206 is shown having nine cameras 300, however it is contemplated that the virtual image sensor assembly 206 may include fewer or more cameras. Each of the cameras 300 may be arranged within the virtual image sensor assembly 206 for movement based on instructions received at the virtual image sensor assembly 206. In one example, the virtual image sensor assembly 206 may include a support component 301 including moveable brackets, each of the moveable brackets structured to receive one of the cameras 300 and to facilitate movement of each of the cameras 300 individually such, for example, as by well-known servo mechanisms. Arrow 304 and arrow 306 represent examples of directions of movement for each of the moveable brackets to move each of the cameras 300. It is also contemplated that each of the cameras 300 may be arranged within the virtual image sensor assembly 206 for manual movement as directed by a user.

In accordance with certain embodiments and with particular reference to FIG. 2A, an apparatus for virtual image acquisition and correction includes virtual image sensor assembly 206 positioned within eyebox 260. The embodiments illustrated are well suited to the controlled production environment of a final assembly plant, though such apparatus may be employed in an after-sale field service environment. A vehicle interior 201 includes dash assembly 209 wherein virtual image generator 105 is contained. Steering column assembly 205 is attached to structural brackets beneath the dash assembly 209. Steering wheel 203 is attached to an end of steering column assembly 205. Steering column assembly 205 may include a tilt/telescoping mechanism which allows for selectively adjusting the steering column/wheel between extreme raised and lowered positions and between extreme fore/aft positions. Virtual image generator 105 is configured to project a test image toward windshield 116. Virtual image sensor assembly 206 is useful in an arrangement wherein the alignment of the test image is automated. The apparatus may include a controller 215 including an associated display or other user/control interface as part of or separate from the virtual image sensor assembly 206, for example a controller and display integrated with the virtual image sensor assembly 206, or a separate smart device such a tablet, laptop computer or the like. The controller 215 may be part of the assembly plant tools or field service equipment, for example. Communications among the controller 102, virtual image sensor assembly 206, controller 215 and associated controller(s), and various in-plant production control and information systems may be carried out by any appropriate wired or wireless means including, for example, the vehicle controller area network 175.

An apparatus for virtual image acquisition and correction may be utilized, as mentioned, during initial vehicle assembly, windshield replacement, or virtual image generator 105 removal and replacement, for example. Thus, it is desirable for repeatability of results to ensure consistent set up. In accordance with the present disclosure's use of virtual image sensor assembly 206 within eyebox 260, a preferred location is defined substantially in accordance with a vehicle reference in mind. For example, features within the vehicle providing reference for an eyebox location may include, for example, one or more of A-pillars, B-pillars, door opening frame, roof or other static, structural features. One exemplary feature may include the vehicle seat tracks 262. FIG. 2A schematically illustrates a fixture 223 fixedly attached to the vehicle seat tracks 262 and carrying the exemplary virtual image sensor assembly 206. Alternatively, a headrest fixture 221 may be fixedly attached to headrest 266 directly or secured to the seatback 264, for example in place of the headrest 266 via posts disposed within headrest post guides at the top of seatback 264. Any such configuration may be considered fixedly attached to the seat back 264. Such a fixture may then carry the exemplary virtual image sensor assembly 206. In such embodiment, the seat may be established into limit positions to reduce the variability of the fixture and virtual image sensor assembly 206 position relative to the vehicle reference frame. Additionally, seat positioning motors may be utilized to establish the limit positions and/or to move the fixture and virtual image sensor assembly 206 into a final desired position. Such adaptable configurations may further be combined with an alignment system (not shown) to locate the fixture in space with respect to the vehicle reference frame. An alignment system may include one or more image cameras in a known vision system, or a known laser alignment system coupled to the fixture, to the virtual image sensor assembly 206, or to the vehicle and indexed to the vehicle reference frame, for example. In another embodiment for locating virtual image sensor assembly 206 within an eyebox, robot assembly 231 may be employed with or without an alignment system as set forth herein. In one example, the robot assembly 231 is located on an assembly line adjacent a track on which vehicle assemblies travel. The robot assembly 231 may include an arm 208. The arm 208 may be fixtured to support virtual image sensor assembly 206. Advantageously, virtual image sensor assembly 206 may include multiple cameras as described herein. Therefore, a preferred approach to repeatably locating virtual image sensor assembly 206 employs the cameras of the virtual image sensor assembly 206. The cameras of the virtual image sensor assembly 206 may be used to scan for preselected vehicle components or positional reference targets, or visually identifiable targets temporarily affixed and referenced to known and identifiable datum locations in the vehicle. Examples of the positional reference targets include vehicle features that are in a fixed and/or an identifiable location within the interior of the vehicle, such as a defroster vent. Such permanent or temporary referential features may herein be referred to as fiducials. In another embodiment, the functions of the cameras of the virtual image sensor assembly 206 may be performed by a dedicated camera or vision system temporarily associated with the interior of the vehicle for locating the preselected vehicle components or other references.

In operation, the virtual image sensor assembly 206 may provide positional reference data as set forth herein. A controller may access data, for example reference locations for preselected vehicle features and compare the reference locations to the positional reference data provided by the virtual image sensor assembly 206. The user may be prompted to positionally adjust the virtual image sensor assembly 206 when the virtual image sensor assembly 206 is adjustably configured, for example affixed to a headrest fixture 221 or affixed to robot assembly 231, as set forth herein. If affixed to the headrest fixture 221, the user may control actuation of the seat positioning motors to establish virtual image sensor assembly 206 into a final desired position based upon the positional reference data provided by the virtual image sensor assembly 206. Alternatively, or additionally, a laser alignment system may be employed to locate the virtual image sensor assembly 206 to its desired position. Similarly, if affixed to the robot assembly 231, the user may control actuation of the robot to establish virtual image sensor assembly 206 into a final desired position based upon the positional reference data provided by the virtual image sensor assembly 206. Advantageously, robot assembly 231 may be adjustable with six degrees of freedom. Alternatively, or additionally, a laser alignment system may be employed to locate the virtual image sensor assembly 206 to its desired position. In accordance with another embodiment with limited adjustability of the virtual image sensor assembly 206 once fixtured, for example when fixtured 223 to the vehicle seat tracks 262 or other vehicle structure, fine adjustments to the exemplary virtual image sensor assembly 206 may be effected at each individual camera 300, such as by servo mechanisms as described herein. Alternatively, or additionally, the virtual image sensor assembly 206 may be fixtured with an intervening adjustment mechanism to allow for final positioning of the virtual image sensor assembly 206 based upon one or more of the positional reference data provided by the virtual image sensor assembly 206, laser alignment system, or other positional feedback tool apparent to one having ordinary skill in the art. When properly configured with controllably adjustable mechanizations, for example robot assembly 231, seat positioning motors, or servo motors, any of the above adjustments may be automated through well-known feedback control.

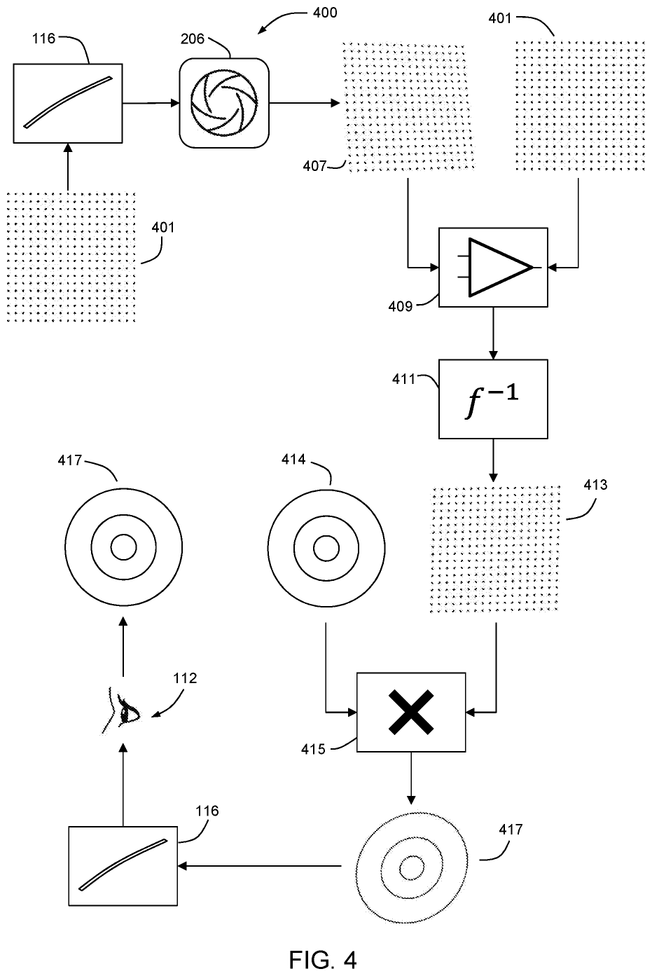

With reference to FIG. 4, an exemplary process 400 for image acquisition and correction in accordance with the present disclosure is illustrated. Virtual image sensor assembly 206 is configured and positioned within eyebox 260 for capturing images within HUD patch 111 as described herein. A predetermined test image 401 is projected by virtual image generator 105. Test image 401 may include one or more identification features, such as a known grid or other quantified geometric pattern including concentric circles and radii, dot patterns and the like. In the present example, a matrix of regularly spaced dots in a two-dimensional cartesian coordinate system is implemented as the test image 401. The test image 401 is directed toward the windshield 116 generally within the HUD patch 111. The virtual image sensor assembly 206 captures the reflected image 407 within the HUD patch 111, including the distortion effects imparted by the reflective surface 118 of the windshield 116 within the HUD patch 111, and provides the HUD patch image to the controller 215. Coordinates of the dots may be extracted. A distortion compensation function 413 is determined by the controller using known undistortion and dewarping techniques based upon comparisons 409 of the dot coordinates of the reflected image 407 to the dot coordinates of the test image 401, and inversion functions 411, for example. A predistorted virtual image 417 for projection by the virtual image generator 105 may be generated by applying 415 the distortion compensation function 413 to an undistorted image 414. Such corrections or compensations may generally be referred to as distortion compensation functions. Preferably, such predistortion may be implemented in non-volatile memory associated with the PGU 104 of the virtual image generator 105 as a calibration thereto and applied to raw images provided by controller 102 for projection and display. Alternatively, such predistortions may be implemented in non-volatile memory associated with the controller 102 as a calibration thereto which applies corrections to raw images prior to provision to the PGU 104 of the virtual image generator 105 for projection and display. Thus, once determined, the distortion compensation function 413 is provided by controller 215 to virtual image generator 105 and integrated therein as part of the virtual image pre-projection processing. The predistorted virtual image 417 is projected by virtual image generator 105. The predistorted virtual image 417 is directed toward the windshield 116 generally within the HUD patch 111. The observer 112 sees the reflected image 417 within the HUD patch 111, including the distortion effects imparted by the reflective surface 118 of the windshield 116 within the HUD patch 111. However, the distortion effects imparted by the reflective surface 118 upon the predistorted virtual image 417 is effective to undistort the predistorted virtual image 417 such that the observed reflected image 417 appears undistorted. Thus, the distortion compensation function is effective to counteract the distortion effects of the reflective surface within the HUD patch.

Preferably, alignment of the virtual image may be accomplished subsequent to determination and integration of the distortion compensation function into the virtual image generator 105. The field of view of the virtual image sensor assembly 206 may also include preselected vehicle component or other permanent or temporary fiducials providing positional reference as described herein. An exemplary virtual image alignment process may include scanning the filed of view of the virtual image sensor assembly 206 and identifying such fiducials. A predetermined test image is projected by virtual image generator 105 and may include one or more identification features. The controller 215 may access data, for example predefined positional relationship data relating the fiducial(s) and the preferred location and alignment of the predetermined test image. The controller may compare the test image location and alignment to the preferred location and alignment and, based upon the differences, effect alignment of the predetermined test image with the preferred location and alignment. Image alignment adjustments are thus determined. Preferably, such image alignment adjustments may be implemented in non-volatile memory associated with the PGU 104 of the virtual image generator 105 as a calibration thereto and applied to raw images provided by controller 102 for projection and display. Such corrections or compensations may generally be referred to as alignment compensation functions. Alternatively, such image alignment adjustments may be implemented in non-volatile memory associated with the controller 102 as a calibration thereto which applies corrections to raw images prior to provision to the PGU 104 of the virtual image generator 105 for projection and display. Thus, once determined, the image alignment adjustments are provided by controller 215 to virtual image generator 105 and integrated therein as part of the virtual image pre-projection processing. Image alignment adjustments may be implemented in various ways depending upon the particular hardware configuration of the HUD system 101 and, more particularly, of the virtual image generator 105. By way of non-limiting examples, adjustment of the virtual image may be effected by rotation of an interior mirror in the case of a DLP HUD system, application of a lens function to a phase hologram in the case of a holographic HUD system, or image translation on an LCD display having reserve pixels, or x,y translation of the entire LCD display in a LCD HUD system.

Color alignment of the virtual image displayed within the HUD patch may also be adjusted or dialed in in similar fashion. For example, a predetermined test image, such as a matrix of regularly spaced dots in a two-dimensional cartesian coordinate system as described herein may be projected by the virtual image generator 105. The virtual image sensor assembly 206 captures the reflected image within the HUD patch 111, including individual color channels and provides the data to controller 215. Coordinates of the dots for each color channel may be extracted and misalignments determined through comparisons. Adjustments to one or more color channels to bring them into alignment are determined. Preferably, such color channel adjustments may be implemented in non-volatile memory associated with the PGU 104 of the virtual image generator 105 as a calibration thereto and applied to raw images provided by controller 102 for projection and display. Such corrections or compensations may generally be referred to as color compensation functions. Alternatively, such color channel adjustments may be implemented in non-volatile memory associated with the controller 102 as a calibration thereto which applies corrections to raw images prior to provision to the PGU 104 of the virtual image generator 105 for projection and display. Thus, once determined, the color channel adjustments are provided by controller 215 to virtual image generator 105 and integrated therein as part of the virtual image pre-projection processing to effect color alignment compensation.

Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

1. A HUD image acquisition and correction apparatus for a vehicle, comprising:
a HUD patch comprising a region of a reflective surface of a windshield of the vehicle wherein HUD virtual images are projected for display to an observer;
a virtual image generator comprising a picture generating unit for projecting images within the HUD patch;
a virtual image sensor assembly comprising at least one camera located within a HUD eyebox region of the vehicle and having a field of view comprising the HUD patch;
an alignment system for locating the virtual image sensor assembly within the HUD eyebox region comprising the at least one camera and fiducials having known locations within the vehicle; and
a controller configured to:
control projection of a predetermined test image within the HUD patch;
receive, from the virtual image sensor assembly, a HUD patch image;
determine a compensation function based upon the predetermined test image and the HUD patch image; and
provide, to the virtual image generator, the compensation function for application to raw images prior to projection.

2. The apparatus of claim 1, wherein the compensation function comprises a distortion compensation function.

3. The apparatus of claim 1, wherein the compensation function comprises an alignment compensation function.

4. The apparatus of claim 1, wherein the compensation function comprises a color compensation function.

5. The apparatus of claim 1, comprising a fixture for the virtual image sensor assembly, the fixture locating the virtual image sensor assembly within the HUD eyebox region of the vehicle.

6. The apparatus of claim 5, comprising the fixture fixedly attached to a static vehicle structure.

7. The apparatus of claim 5, comprising the fixture fixedly attached to a seat back.

8. The apparatus of claim 5, comprising the fixture fixedly attached to a robot assembly located on an assembly line.

9. (canceled)

10. The apparatus of claim 1, the virtual image sensor assembly comprising a plurality of individually, positionally adjustable cameras.

11. (canceled)

12. (canceled)

13. (canceled)

14. (canceled)

15. The apparatus of claim 7, comprising seat positioning motors, the controller configured to control the seat positioning motors to move the fixture and virtual image sensor assembly into a final desired position within the HUD eyebox region.

16. A HUD image acquisition and correction apparatus for a vehicle, comprising:
a HUD patch comprising a region of a reflective surface of a windshield of the vehicle;
a virtual image generator comprising a picture generating unit for projecting images within the HUD patch;
a virtual image sensor assembly located within a HUD eyebox region of the vehicle and having a field of view comprising the HUD patch, the virtual image sensor assembly comprising a plurality of cameras;
an alignment system for locating the virtual image sensor assembly within the HUD eyebox region comprising at least one of the plurality of cameras and fiducials having known locations within the vehicle; and
a controller configured to:
control projection of a predetermined test image within the HUD patch;
receive, from the virtual image sensor assembly, a HUD patch image comprising the predetermined test image reflected off the reflective surface of the windshield, the HUD patch image providing information corresponding to distortion effects of the reflective surface within the HUD patch to the controller;
determine a distortion compensation function based upon the predetermined test image and the HUD patch image, the distortion compensation function effective to counteract the distortion effects of the reflective surface within the HUD patch; and
provide, to the virtual image generator, the compensation function for application to raw images prior to projection.

17. The apparatus of claim 16, comprising a fixture for the virtual image sensor assembly, the fixture locating the virtual image sensor assembly within the HUD eyebox region of the vehicle.

18. The apparatus of claim 17 comprising the fixture fixedly attached to one of a static vehicle structure, a seat back, and a robot assembly.

19. A HUD image acquisition and correction method for a vehicle, comprising:
projecting, from a virtual image generator comprising a picture generating unit, a predetermined test image within a HUD patch comprising a region of a reflective surface of a windshield of the vehicle;
with an alignment system comprising at least one camera and fiducials having known locations within the vehicle, locating a virtual image sensor assembly within a HUD eyebox region of the vehicle, the virtual image sensor assembly comprising the at least one camera;
receiving, from the virtual image sensor assembly located within the HUD eyebox region of the vehicle and having a field of view comprising the HUD patch, a HUD patch image comprising the predetermined test image reflected off the reflective surface of the windshield;
determining a compensation function based upon the predetermined test image and the HUD patch image; and
providing, to the virtual image generator, the compensation function for application to raw images prior to projection.

20. The method of claim 19, wherein the compensation function comprises at least one of a distortion compensation function, an alignment compensation function, and a color compensation function.
